(19) United States
(12) Patent Application Publication
(10) Pub. No.: US 2026/0277679 A1
(43) Pub. Date: Sep. 17, 2026

(54) MEMORY ACCESS SCHEDULING FOR PARALLEL COMPUTATIONS USING A PROCESSING-IN-MEMORY ARCHITECTURE

(71) Applicant: Google LLC, Mountain View, CA (US)

(72) Inventors: Hee jun Park, San Diego, CA (US); Inho Hwang, San Diego, CA (US); Hongil Yoon, San Jose, CA (US)

(21) Appl. No.: 19/167,078

(22) PCT Filed: Feb. 27, 2025
(86) PCT No.: PCT/US2025/017539

§ 371 Date: Sep. 19, 2025

Related U.S. Application Data
(60) Provisional application No. 63/560,601, filed on Mar. 1, 2024.

(51) Int. Cl. G06F 9/50

(52) U.S. Cl. CPC G06F 9/5016

(57) ABSTRACT

Methods, systems, and apparatus, including computational instructions/programs encoded on non-transitory computer-readable media, are disclosed for command and memory access scheduling at an integrated circuit. A system determines a performance target for executing an ML workload and based on a first priority, schedules commands for compute operations for executing the workload at a processor-in-memory (“PiM”) block of a memory device. For concurrent memory transactions of both PiM commands for the compute and memory access requests, the system determines a prospective violation of the performance target for the workload and addresses the prospective violation by adjusting the first priority to exceed a second priority assigned to the memory requests. The system satisfies both the performance targets for executing the ML workload at the PiM block and processing memory requests by adjusting the first priority to exceed the second priority and adjusting an operating frequency of the memory device and PiM block.

### BACKGROUND

This specification generally relates to memory access transactions.

Modern computing systems often incorporate a wide variety of compute processing units that each offer different computing capabilities and trade-offs. Efficient execution of a given compute job often involves parsing computations into meaningful sub-tasks or workloads that are mapped to available processor cores of a computing system. The computations may be parsed and mapped based on suitability criteria, such as processor capability, performance, and power. Generally, this overall process of allocating portions of a computation to appropriate processor resources is referred to as heterogeneous computing.

At least one processor core of the computing system can be an Intellectual Property block (“IP block”) that executes a respective portion of a computational operation for different multimedia workloads. Example use cases can involve processing image or speech data captured respectively by a camera or microphone on the mobile device as well as performing computations for generative artificial intelligence (“GenAI”) applications. The system can use a heterogeneous computing operation to process input samples derived from image data, speech data, a text corpus, or a combination of these. An example step in the heterogeneous computation can include processing data associated with the input samples using a memory device that provides in-memory processing or computing capabilities.

### SUMMARY

This specification describes hardware and software techniques for memory access scheduling in concurrent use case scenarios using a Processing-in-Memory (“PiM”) architecture of a memory device. The techniques are implemented using an integrated system that includes data processing resources in the memory device that enable and/or facilitate signal communications with a host device/core in a system-on-chip (“SoC”) of the integrated system.

The memory device can be a dynamic random-access memory (DRAM) device with an example PiM architecture. The PiM architecture defines one or more PiM blocks of the memory device and each PiM block includes computing resources/elements, such as a processor unit, mode registers, and one or more computational units, e.g., arithmetic logic units (ALUs) or related addition and multiplication circuitry. For example, the PiM block can include discrete processors, processor units, register devices, buffers, multiply accumulate cells (MACs), etc. that cooperate to form one or more PiM compute elements.

The PiM blocks are used to execute computations for an example workload, such as a machine-learning workload for computing outputs associated with a generative artificial intelligence (“GenAI”) application. The machine-learning computations can be segmented into respective portions that are allocated between the SoC and one or more PiM blocks of the memory device. The disclosed techniques provide an advantageous quality of service (“QoS”) scheme that dynamically changes the memory-traffic scheduling policy for memory transactions, where the memory transactions include: i) memory access requests (e.g., read request and write request) and ii) PiM operation commands.

The SoC can implement this QoS policy to ensure an ML workload is executed in compliance with a given performance requirement, such as a target completion time for executing the workload. For example, to meet the performance requirement the system 100 can automatically prioritize PiM commands to expedite execution of PiM operations at the memory device, which in turn speeds up execution of the ML workload. This dynamic QoS scheduling policy can be used to satisfy respective performance targets for memory accesses and PiM operations in support of ML workload execution.

One aspect of the subject matter described in this specification can be embodied in a method implemented using an integrated circuit including a System-on-Chip (“SoC”) and a memory device coupled to the SoC. The method includes determining a performance target for executing a machine-learning (ML) workload; and scheduling, based on a first priority, commands for compute operations at a processor-in-memory (“PiM”) block of the memory device to execute the ML workload at the integrated circuit. The method also includes determining a prospective violation of the performance target; addressing the prospective violation by adjusting the first priority to exceed a second priority assigned to memory read/write transactions provided to the memory device; and satisfying the performance targets of the ML workload at the PiM block and memory read/write transactions in response to adjusting the first priority to exceed the second priority and adjusting an operating frequency of the memory device and the PiM block.

These and other implementations can each optionally include one or more of the following features. For example, in some implementations, i) the commands and the memory read/write transactions are processed concurrently for at least one task of the ML workload; and ii) the commands and the memory read/write transactions share an interface communication channel between the SoC and the memory device. In some implementations, executing the ML workload and satisfying the performance target can include: after adjusting the first priority to exceed the second priority, performing any remaining compute operations based on an adjusted first priority that prioritizes sending PiM commands to the PiM inside the memory device over read/write memory transactions.

In some implementations, the first priority is a PiM command routing and execution priority and the second priority is a memory access transaction routing and execution priority. In some cases, adjusting the first priority to exceed the second priority occurs at a first time period to prioritize PiM commands over memory access transactions, and the method further includes reprioritizing memory access transactions over PiM commands at a second time period by adjusting the second priority to exceed the first priority used to perform the compute operations, where the second time period occurs later in time than the first time period. In some implementations, memory transactions are processed at the memory device concurrently with performing the compute operations at the PiM block of the memory device. In some implementations, i) the ML workload is for a large language model (“LLM”); and ii) the ML workload corresponds to an iteration of the LLM; and iii) the performance target is an end-to-end target completion time for executing an iteration of the LLM.

In some cases, determining a prospective violation of the performance target of the PiM processing ML workload can include determining a prospective violation in response to determining that an actual time needed to execute the ML workload will exceed the end-to-end target completion time. In some implementations, adjusting the first priority to exceed the second priority can include adjusting the first priority to exceed the second priority based on a Quality-of-Service (“QoS”) policy implemented by a memory controller of the SoC. In some cases, adjusting the first priority to exceed the second priority further includes based on the QoS policy, interspersing PiM commands with memory transaction requests; routing, to the memory device, the PiM commands interspersed with the memory transaction requests; and processing the PiM commands and the memory transaction requests concurrently at the memory device.

In some implementations, i) the memory read/write transactions are for data reads and data writes from the SoC to the memory device, ii) the data reads and the data writes are for data transfer and are distinct from commands that are provided to the PiM block in the memory device, and iii) the performance target for executing the ML workload includes a latency target of memory read/write transactions and a bandwidth or throughput target for each individual memory read/write transaction.

Another aspect of the subject matter described in this specification can be embodied in a method implemented using a hardware integrated circuit that includes a memory device and a processing-in-memory (“PiM”) architecture in the memory device. The method includes determining, for a set of PiM commands, an end-to-end target completion time for executing PiM operations in a PiM architecture; and tracking, during execution of the PiM operations in the PiM architecture, a progress proportion (or percentage) of completed PiM operations relative to an elapsed time proportion (or percentage) of the end-to-end target completion time. The method also includes, in response to determining that the progress percentage is less than the elapsed time percentage, increasing a scheduling priority of remaining PiM operations relative to priorities of memory transactions for execution at a memory bank of the memory device; and in response to increasing the scheduling priority of the remaining PiM operations, executing the remaining PiM operations using the processing-in-memory architecture and executing the memory transactions by accessing the memory bank of the memory device.

These and other implementations can each optionally include one or more of the following features. For example, in some implementations, the method further includes determining the elapsed time percentage as a fraction of an elapsed time of the completed PiM operations divided by the end-to-end target completion time. In some implementations, the method further includes determining the progress percentage as a fraction of a number of completed operations divided by a sum of the number of completed operations and the number of remaining operations. In some implementations, the method further includes mapping PiM command priorities to latency and bandwidth requests. In some cases, the method further includes determining that performance targets of PiM commands and memory transactions are not satisfied, and increasing a respective operating frequency of: i) a memory controller of the hardware integrated circuit, ii) the memory device, and iii) a processor in the PiM architecture.

Another aspect of the subject matter cover in this specification can be embodied in an integrated circuit including, a System-on-Chip (“SoC”), a memory device coupled to the SoC, and a processor and a non-transitory machine-readable storage medium for storing instructions that are executable by the processor to cause performance of operations. The operations include determining a performance target for executing a machine-learning (ML) workload; and scheduling, based on a first priority, commands for compute operations at a processor-in-memory (“PiM”) block of the memory device to execute the ML workload at the integrated circuit, determining a prospective violation of the performance target. The method also includes addressing the prospective violation by adjusting the first priority to exceed a second priority assigned to memory read/write transactions to the memory device, and satisfying the performance target of the ML workload at the PiM block and the memory read/write transactions in response to adjusting the first priority to exceed the second priority and adjusting an operating frequency of the memory device and the PiM block.

These and other implementations can each optionally include one or more of the following features. For example, in some implementations, executing the ML workload and satisfying the performance target includes after adjusting the first priority to exceed the second priority performing any remaining compute operations based on an adjusted first priority that prioritizes sending PiM commands to the memory device over memory read/write transactions at the memory device. In some cases, the first priority is a PiM command routing and execution priority, and the second priority is a memory access transaction routing and execution priority.

In some implementations, adjusting the first priority to exceed the second priority occurs at a first time period to prioritize PiM commands over memory access transactions, and the operations further include reprioritizing memory access transactions over PiM commands at a second time period by adjusting the second priority to exceed the first priority used to perform the compute operations, wherein the second time period occurs later in time than the first time period. In some implementations, the memory transactions to memory are transferred to the memory device concurrently with the PiM commands to the PiM block of the memory device through a shared interface and communication channel.

In some cases, i) the ML workload is for a large language model (“LLM”); ii) the ML workload corresponds to an iteration of the LLM; and iii) the performance target is an end-to-end target completion time for executing an iteration of the LLM. In some implementations, i) the memory read/write transactions are for data reads and data writes from the SoC to the memory device; ii) the data reads and the data writes are for data transfer and are distinct from commands that are provided to the PiM block in the memory device; and iii) the performance target for executing the ML workload comprises a latency target of memory read/write transactions and a bandwidth (or throughput) target for each individual memory read/write transaction.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation causes the system to perform the actions. One or more computer programs can be so configured by virtue of having instructions that, when executed by a data processing apparatus, cause the apparatus to perform the actions.

The subject matter described in this specification can be implemented in particular embodiments to realize one or more of the following advantages. The techniques of the present disclosure can be used to solve the technical problem of inefficiencies that are often present in an integrated circuit that includes an SoC coupled to a memory device that has a PiM architecture. Specifically, existing architectures are not known to readily include a mechanism to schedule PiM-command traffic together with normal/routine memory transaction traffic, while meeting performance targets for workload execution and requirements for PiM operations.

In existing systems, for example, sources of routine (or regular) memory transaction traffic, such as read-write access requests, can originate in any IP block of the SoC 102, such as an inference accelerator or a graphics/display processor. The memory transactions can be for reading data from, or writing data to, a memory location/cell in a DRAM bank of the memory device. However, the addition of PiM commands creates a new challenge for PiM/SoC architectures. Using the disclosed techniques, a memory controller of the SoC can be configured to support different performance and latency requirements that drive prioritizing executing PiM commands and operations over memory access transactions.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a block diagram of an example computing system with at least one SoC.

FIG. 2 shows an example PiM architecture with corresponding compute elements.

FIG. 3 shows an example timeline sequence of PiM commands and memory transaction requests.

FIG. 4 shows an example PiM request sequence.

FIGS. 5A-5B collectively show an example of changes made to PiM priorities based on a comparison of the progress proportion and the elapsed time proportion.

FIG. 6 shows examples of coalescing PiM operations and memory transactions based on changes in execution priority.

FIG. 7A is an example process for adjusting priorities of PiM operations.

FIG. 7B shows an example software stack for implementing a policy for PiM command priority adjustments.

FIG. 8 is an example process for memory operation scheduling for concurrent processing in a memory device.

Like reference numbers and designations in the various drawings indicate like elements.

### DETAILED DESCRIPTION

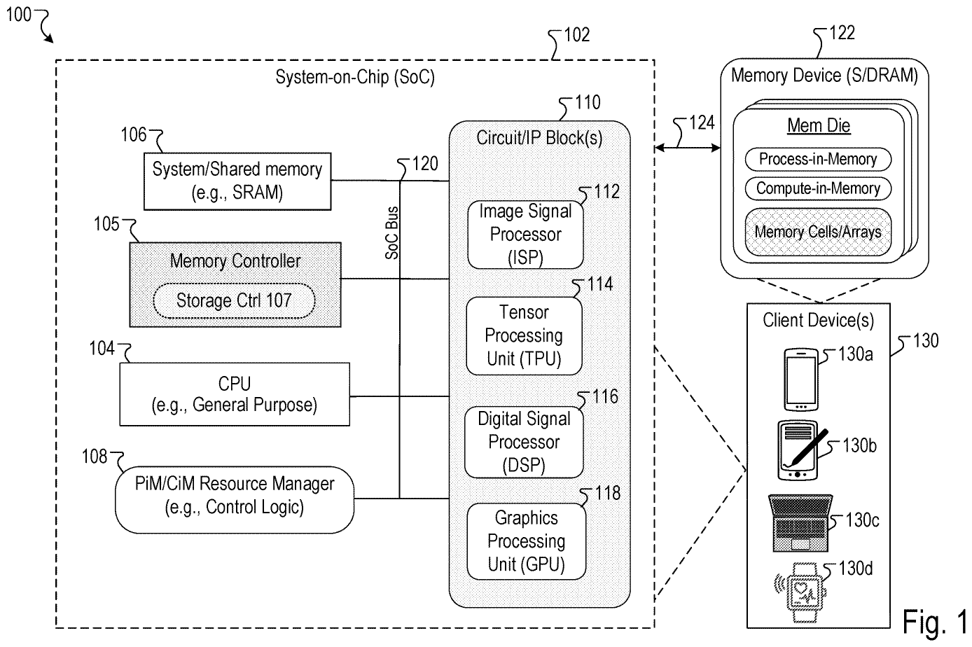

FIG. 1 is a block diagram of an example computing system 100 that includes a system-on-chip 102 (“SoC 102”). The SoC 102 includes a central processing unit 104 (“CPU 104”), a memory controller 105, a shared memory 106 (“memory 106”), a resource manager 108, and an IP/circuit block 110. In some implementations, system 100 can include multiple SoCs and any descriptions for the SoC 102 will apply equally to each of the multiple SoCs that may be included at system 100.

The CPU 104 can be a general-purpose CPU (e.g., a single or multi-core CPU). The CPU 104 generates one or more indicators, such as an app-launch indicator or a function call that is triggered in response to executing or launching an application at a user device. For example, the application can be a camera application that uses an imaging sensor to generate image data or a gaming application that requires substantial memory and graphics processing resources to render graphical content of the game. The CPU 104 also generates one or more application values, such as pixel values or frame rate. The application values may be associated with a function call, may be descriptive of an event that occurs during execution of the application, or both.

The memory 106 is a system memory, shared memory, or both. In the example of FIG. 1, memory 106 is depicted external to circuit block 110. However, memory 106 can include portions of memory that are: i) specific to circuit block 110, ii) external to circuit block 110, or iii) both. The memory 106 can be random access memory of the SoC 102, such as static random access memory (SRAM), dynamic random access memory (DRAM), a synchronous DRAM (SDRAM), or double data rate (DDR) SDRAM.

In some implementations, aspects of memory 106 are configured as a shared scratchpad memory that supports parallel access of its memory resources by two or more processors of the circuit 110. The memory 106 can also include various other types of memory, such as high bandwidth memory (HBM), narrow memory (e.g., for storing 8-bit values), wide memory (e.g., for storing 16-bit or 32-bit values), etc.

The resource manager 108 is implemented in hardware and software. Aspects of the resource manager 108 can be also implemented as firmware of the SoC 102 or firmware of a device of the SoC 102, such as a DRAM memory device or the CPU 104. The resource manager 108 is a processor-in-memory (PiM) resource manager (“PiM resource manager 108”) that includes control logic implemented in hardware, software, or both. For example, the PiM resource manager 108 can include resources such as flip-flops, registers, buffers, etc. that are implemented in hardware and control logic (e.g., programmed code) that is implemented in software.

The circuit block 110 generally includes individual IP devices such as processors, processor cores, or special-purpose processing devices. For example, the circuit block 110 can include an image signal processor (ISP) 112, a host (or special-purpose) processing unit (HPU) 114, a digital signal processor (DSP) 116, and a graphics processing unit (GPU) 118. The host device/processor 114 can be a special-purpose neural network processor or hardware ML accelerator configured to accelerate computations for generating different types of data processing and ML outputs. The circuit block 110 is referred to alternatively as an IP block 110, where the IP block can include one or more proprietary hardware elements. For example, each of the ISP 112, HPU 114, DSP 116, and GPU 118 can be a respective proprietary IP block (or IP device) of a particular entity or device manufacturer.

One or more aspects of the PiM resource manager 108 can be implemented as a software routine (or module) of the CPU 104, which uses one or more hardware resources of the CPU 104, such as registers, buffers, etc. The CPU 104 can be configured as an instruction and vector data processing engine that processes data obtained from a system memory of the SoC 102, such as memory 106. In some implementations, each processor (e.g., ISP 112, DSP 116, HPU 114, GPU 118) of the SoC 102 includes multiple cores and the CPU 104 and/or the PiM resource manager 108 can generate control signaling 124 to manage and distribute memory intensive compute operations to a memory device 122 (e.g., DRAM) to minimize the processing load at each core of the processors. The control signaling 124 is routed at system 100 using an example bus 120 of the SoC 102. The control signaling 124 can include commands, requests, data, instructions, or combination of these.

The PiM resource manager 108 cooperates with the CPU 104, memory controller 105 and storage controller 107 to dynamically control and manage one or more compute-in-memory (CiM) operations. In some implementations, the CiM operations are executed at the SoC 102 in support of a heterogeneous compute operation between two or more processing units that are included among the IP block 110, the CPU 104, or both. More specifically, the PiM resource manager 108 is configured to generate control signaling 124 and use one or more discrete signal values of the control signaling 124 to manage and boost data access operations at the memory device 122.

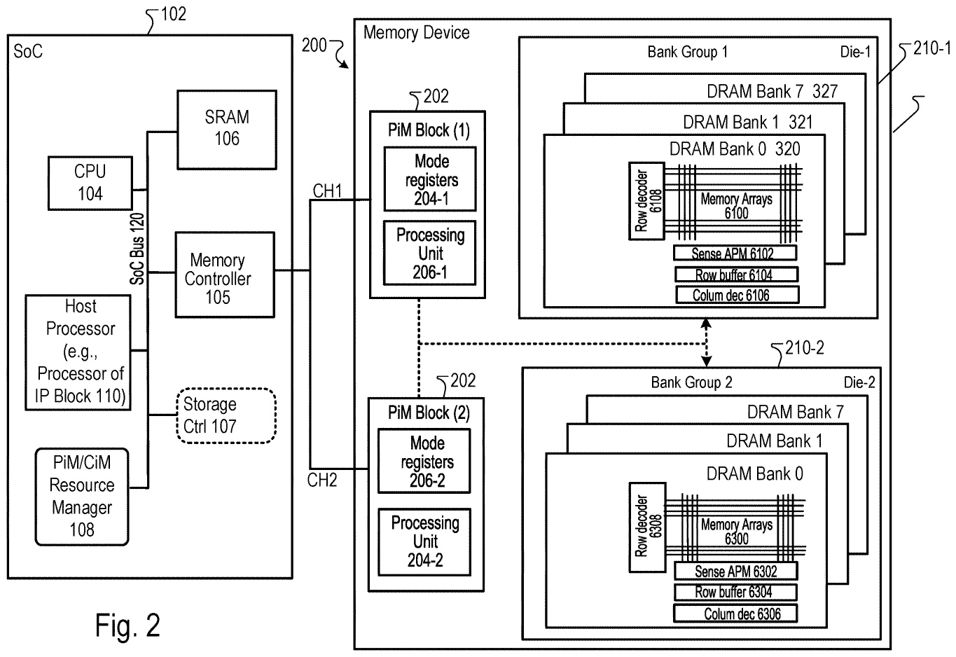

The system 100 includes an example memory device 122. The memory device 122 can include multiple memory dies. For example, the memory device 122 can include N memory die, where N is an integer greater than 1. The memory device 122 can be a dynamic random-access memory (DRAM) or Double Data Rate (DDR) synchronous DRAM (SDRAM). The memory device 122 is configured to perform or support various types of PiM operations, CiM operations, and memory-near-computing operations (“MnC operations”). The memory device 122 performs or supports these operations using its multiple PiM compute elements, which are described below with reference to at least FIG. 2.

The SoC 102 cooperates with the memory device 122 to perform computations across one or more bank groups of the memory device 122. The computations can be for operations or workloads that involve one or more of the processors at IP block 110. Additionally, the computations can be for a heterogenous operation that spans multiple processors of IP block 110, multiple IP blocks 110, or both. In at least one example the memory device 122 may be external to the SoC 102, whereas in another example the memory device 122 may be internal to the SoC 102.

In the example of FIG. 1, system 100 and the SoC 102 is an integrated circuit of an example user/client device 130, consumer electronic device, or mobile device, where each of these devices can include items such as a smartphone 130a, tablet 130b, laptop 130c, smartwatch or wearable device 130d. The devices 130 may also include other items such as an eNotebook, Netbook, smart speaker, or mobile computer. In some implementations, the system 100 and the SoC 102 are integrated circuits of a desktop computer, network server, or related cloud-based asset.

FIG. 2 shows an example processor-in-memory (PiM) architecture 200 for boosting PiM data access performance based on control signals generated using the SoC 102, the memory device 122, or both. In the example of FIG. 2, the memory device 122 includes a first memory die-1 with a first bank group that has multiple memory banks, where each memory bank includes one or more memory arrays and a second memory die-2 with a second bank group that has multiple memory banks, where each memory bank includes one or more memory arrays. In some implementations, the PiM architecture 200 includes multiple bank groups, multiple memory die, or both. For example, a single memory die can include multiple bank groups and/or multiple bank groups can be distributed across multiple memory die.

The PiM architecture 200 includes multiple PiM blocks, where each PiM block includes multiple compute elements. For example, a first PiM block of PiM architecture 200 includes mode register 204-1 and process unit 206-1, whereas a second, different PiM block of PiM architecture 200 includes mode register 204-2 and process unit 206-2. Each process unit 206-1, 206-2 can include a processor, a processor unit, or a processor core, such as a CPU. Each process unit 206-1, 206-2 can also include an example computation unit such as an arithmetic logic unit (ALU) or multiply-accumulate cell (MAC).

In some implementations, the PiM architecture 200 is included in the memory device 122 as multiple discrete integrated circuits, where each integrated circuit is local to a given memory die (e.g., die-1 and die-2) and interacts or communicates with arrays of memory cells at that memory die. For example, the PiM architecture 200 can include compute elements that are replicated and distributed across each of the memory die in the memory device 122. In some other implementations, the PiM architecture 200 is included in the memory device 122 as a single integrated circuit that interacts or communicates with each memory die of the memory device 122, including the arrays of memory cells at each memory die.

To boost PiM data access performance as described in this specification, the PiM blocks or process units in the PiM architecture 200 are located within the memory device 122 but outside of a section of the memory device 122 that includes the bank groups. The section may be defined as a discrete memory die or defined in some other way (e.g., a portion of a memory die). Irrespective of the hardware configuration or layout of PiM architecture 200, the PiM blocks are sufficiently external to the bank groups such that the PiM blocks communicate with the bank groups based on a particular timing constraint that can be leveraged to boost PiM data access performance with cross bank group data aggregation. A data channel/interconnection can be established between the individual memory arrays of a memory bank and a corresponding processor unit and/or mode register of a PiM block 202.

The PiM operations can be managed and executed at the memory device 122 using a processor device that provides functionality similar to a central processor, such as CPU 104. The CiM operations and MnC operations can include standard arithmetic operations, such as computations normally performed by an ALU or MAC. The CiM operations and MnC operations can also include computational functions of a HPU 114, such as multiplication and addition operations for matrix math, vector computations, linear algebra, and dot-product accumulations. In some implementations, each of the PiM operations, CiM operations, and MnC operations are performed in support of machine-learning computations, neural network computations, or both.

In some implementations, the PiM operations are an extension of the computational functions of the HPU 114. For example, a PiM block can generate accumulated values from sets of weight values/inputs and activation inputs obtained from memory banks of different bank groups in the memory device 122. The accumulated values are generated based on neural network computations performed using a computational array of the PiM block. The computational array can be a matrix multiplication unit with compute cells that are arranged as a systolic array. The accumulated values can be dot products of the sets of weight values and the activation inputs. That is, for a set of weights, the PiM block multiplies each weight with each activation input and sums the products together to form an accumulated value.

The PiM architecture 200 can include a register or other portion of memory for storing data for a respective memory die or group of memory banks. For example, the data can be mode/configuration values. The data can also describe errors that occurred during a compute operation at a corresponding PiM block of the memory device 122, or both. In some implementations, the register or other portion of memory is used to store configuration information, or associated instructions, for configuring aspects of a PiM block, or respective memory die, group of memory banks, or a combination of these.

For example, the mode registers 204-1, 204-2 can be used to control or trigger selection of a particular mode in a PiM architecture, such as an error-capture mode, interleave configuration mode, multi-batch processing mode, etc. In some implementations, a particular mode is selected based on bit values of the mode registers 204-1, 204-2. For example, to trigger or select an interleave configuration mode(s) or multi-batch processing mode(s), a single bit, or a sequence of bits, can be defined for use in the mode register.

Using the disclosed techniques, data access operations are optimized by reading memory cells of bank groups at a frequency that exceeds other read operations that are subject to certain delay constraints for executing successive reads against banks of the memory device 122. For example, an internal controller of the PiM block (1), (2) can execute successive read commands at a frequency that is based on a clock cycle generated by the memory device 122. The internal controller can operate based on a particular clock frequency, e.g., a 200 or 800 MHz clock or 1000 MHz clock. Other clock frequencies are also within the scope of this disclosure.

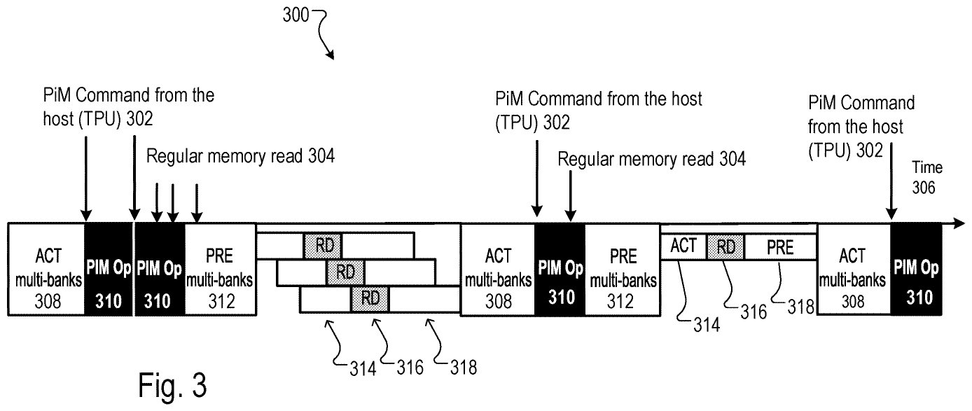

FIG. 3 shows an example timeline sequence 300 of PiM commands and memory transaction requests in which a shared memory path is used to route the requests and commands to the memory device 122. In the example of FIG. 3, the request sequence 300 includes PiM commands 302 from a host device (e.g., HPU 114) of the SoC 102 and memory transaction requests 304 over a timeline 306. Although FIG. 3 indicates the memory transaction requests are memory reads, it should be noted that memory writes are also supported by the disclosed techniques, and within the scope of this disclosure.

Each group of PiM commands 302 includes an activation 308 of a multi-bank, PiM operation execution 310, and a pre-charge 312. A host (e.g., SoC or HPU 114) processes compute-intensive workloads and the PiM processes memory access-intensive workloads, for example, to speed up an overall end-to-end execution pipeline. In concurrent use case scenarios, multiple IPs (e.g., CPU 104, GPU 118, Camera/ISP 112, etc.) can generate memory transaction traffic, such as data reads and writes, for routing to the memory device 122. The host device concurrently generates PiM-related commands for routing to a PiM block 202 of the memory device 122 using the same memory-path.

The shared memory path in the example of FIG. 3 can cause starvations (e.g., bottlenecks and unbalanced processing) in either or both of PiM command traffic and memory access traffic. In some implementations, a priority assigned to PiM commands is indicated as having a lower priority relative to a priority assigned to regular/routine memory transactions, such as memory transactions other than PiM commands. Based on this lower priority, the memory controller 105 can be configured to preempt routing PiM commands that trigger execution of PiM operations in favor of routing and executing routine memory accesses that require short latency. In some implementations, priority determinations, assignments, and priority changes (e.g., either increasing or decreasing priority) are executed at the SoC 102, for example, using the CPU 104, the host 114, or both. Priority operations can also be executed by the memory controller 105, either independently, or in coordination with the CPU 104, the host 114, or both.

The techniques of the present disclosure can be used to solve the technical problem of inefficiencies that are often present in an integrated circuit that includes an SoC 102 coupled to a memory device 122 that has a PiM architecture. Specifically, existing architectures are not known to readily include a mechanism to schedule PiM-command traffic together with normal/routine memory transaction traffic, while meeting performance targets for workload execution and requirements for PiM operations.

In existing systems, for example, sources of routine memory transaction traffic, such as read-write access requests, can originate in any IP block of the SoC 102, e.g., CPU 104, GPU 118, ISP 112, HPU 114, including other IP devices such as GSO or DPU. The memory transaction request can be for reading data from, or writing data to, a memory location/cell in a DRAM bank of the memory device 122. In some implementations, certain key process indicators (KPIs) associated with executing memory transactions include: 1) latency from a read instruction to data arrival at the client IP block, 2) bandwidth or throughput of a data being accessed, and 3) DRAM data transfer efficiency (e.g., the actual transferred data amount divided by the theoretical maximum data transfer rate). However, the addition of PiM commands creates a new challenge for PiM/SoC architectures.

For example, the memory controller 105 can be configured to support the strict latency requirements that drive the prioritization of memory access transactions over executing PiM commands and operations. In some implementations, the system 100 experiences instances of preemption that cause inefficiencies due to an excessive number of activations and pre-charges across banks/cells of the memory device 122 rather than actual read/writes operations against the banks/cells. For a given memory transaction the memory device 122 can activate (or open) one or more rows/cells of the memory device (314), conduct a read/write operation (316), and then close the row/cell by re-charging the row/cell (318). In some implementations, the activations 308 and pre-charges 312 are essentially overhead corresponding to a group of one or more PiM operation executions 310 in which actual operations are occurring.

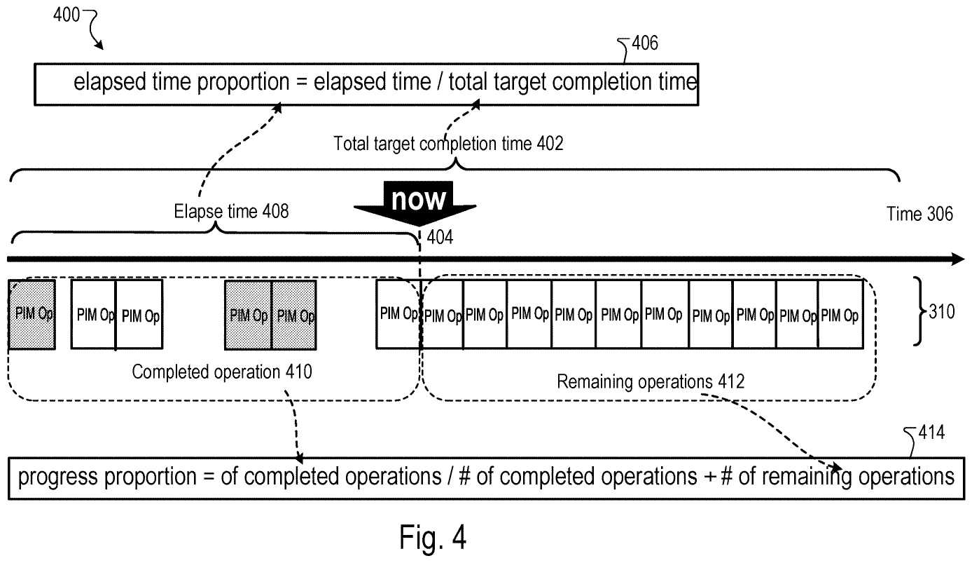

FIG. 4 shows an example PiM request sequence 400. In the example of FIG. 4, at the beginning of a Large Language Model (“LLM”) iteration, the host (e.g., HPU 114) can determine an end-to-end total target completion time 402 of the iteration. In some implementations, the end-to-end target completion time 402 can be calculated based at least on a number of tokens per second in the LLM and a total number of PiM operations 310 to complete.

During sequence 400 multiple PiM commands can be sent to perform or execute multiple corresponding PiM operations. The multiple PiM commands 302 and PiM operations 310 can be performed to execute an example ML workload. During the execution of the PiM commands 302, the host (e.g., HPU 114) can track a progress proportion that is compared over time 306 with an elapsed time proportion 406. For example, the host or the SoC 102 can track a progress proportion at a given “now” time 404.

In some implementations, the elapsed time proportion 406 is calculated as a fraction of an elapsed time 408 (of completed operations 410) divided by the end-to-end target completion time 402. At this time, remaining operations 412 are yet to be executed. In some implementations, a progress proportion 414 is calculated as a fraction of a number of completed operations 410 divided by a total number of operations or a sum of the number of completed operations 410 plus the number of remaining operations 412. For example, if the operations 410 includes 100 computational tasks, the progress proportion 414 can be calculated as N/100, N is a number of completed operations 410.

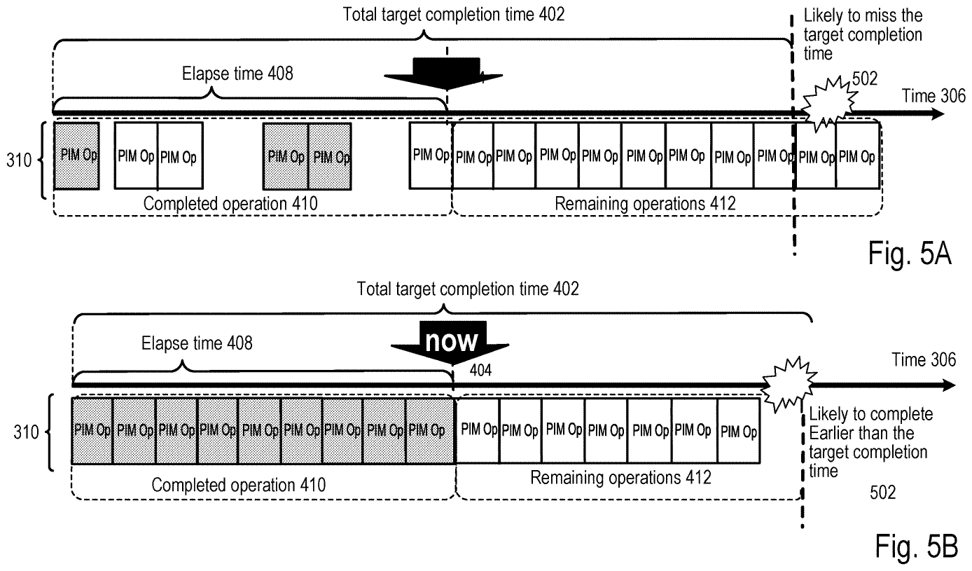

FIGS. 5A-5B collectively show an example of changes made to PiM priorities based on a comparison of the progress proportion 414 and the elapsed time proportion 406.

For example, this comparison can be made in reference to the PiM commands to be executed with reference to FIG. 4. Referring to FIG. 5A, if the progress proportion 414 is less than the elapsed time proportion 406, then the priority assigned to PiM commands is increased. This can occur, for example, when it is likely that the target completion time will be missed. Increasing the priority assigned to PiM commands in this way will give PiM commands priority over memory transaction requests 304. In some implementations, each of the time proportion and progress proportion can be computed, determined, or otherwise characterized as a percentage value or a ratio value. For example, the

[symbol]

In some implementations, the SoC 102 generates different priority parameters based on a prioritization logic (or algorithm) executed using the CPU 104, the memory controller 105, or both. In some cases, the SoC 102 generates respective priorities and corresponding priority parameters for different workloads and memory transactions based on prioritization schemes that are executed using one or more of the CPU 104, resource manager 108, a host processor of the SoC 102, the memory controller 105, or a PiM block of a PiM architecture in the memory device 122.

For example, the SoC 102 can execute different workloads, such as an image processing workload for the ISP 112 or part of an LLM workload executed using the HPU 114. The SoC 102 (e.g., CPU 104) can establish a respective priority for each workload based on, for example, a corresponding performance target or requirement of each workload. For example, the prioritization logic can receive the corresponding performance target for each of the ISP workload (e.g., frames-per-second (fps) sensitivity) and the LLM workload (e.g., latency critical) and use each target value to establish respective priorities for each workload in accordance with those corresponding performance target. For example, the performance target for the image processing workload can specify a threshold fps requirement, whereas the performance target for the LLM workload can be latency critical based on a minimum requirement for computing word tokens for presenting a generative reply to a user.

In some implementations, the prioritization logic is used by the SoC 102 to establish a respective priority for different memory transactions arbitrated by the memory controller 105. For example, the different memory transactions can be tied to a corresponding one of the two workloads and can be required to execute the corresponding workload in accordance with its associated performance target. In some implementations, SoC 102 can generate a priority parameter based on the prioritization logic. For example, the memory controller 105 can generate “HIGH” or “LOW” priority parameter using a one-bit flag or generate more granular priority parameters using an N-bit parameter, where N is an integer greater than one. In some implementations, a priority parameter that indicates a corresponding priority of a PiM command is passed to the PiM block and stored as a configuration setting of a control (or mode) register of the PiM block. For example, the priority parameter is passed to the PiM block by the memory controller 105.

Referring to FIG. 5B, if the progress proportion 414 is greater than the elapsed time proportion 406, then the priority assigned to PiM commands is decreased. This can occur, for example, when it is likely that the PiM commands will complete earlier than the target completion time. Decreasing the priority assigned to PiM commands will give routine memory read requests 304 priority over PiM commands. Doing so will allow memory read requests 304 to occur without negatively impacting the likelihood that the PiM commands will still complete before the end of the target completion time. That is, the memory transactions, e.g., the memory read requests 304, can be reprioritized over PiM commands by adjusting the priority assigned to the memory transactions to exceed, or be higher relative to, the priority assigned to PiM commands.

In some cases, adjusting the first priority to exceed the second priority occurs at a first time period to prioritize PiM commands over memory access transactions. The SoC 102 can then reprioritize memory access transactions over PiM commands at a second time period by adjusting the second priority to exceed the first priority used to perform the compute operations. The second time period occurs later in time than the first time period. For example, the memory controller 105 can determine to reprioritize memory access transactions over PiM commands by adjusting the second priority to exceed the first priority in response to determining that the prospective violation has been addressed. The prospective violation can be addressed (e.g., mitigated) based on the prior change where the first priority was adjusted to exceed the second priority. For example, a prospective violation can be addressed based on updated calculations that indicate progress of executing PiM commands for an in-memory compute iteration is greater than the elapsed time required to execute the commands and compute operations in accordance with a performance target.

In some implementations, changes in priority based on the comparison of the progress proportion 414 and the elapsed time proportion 406 can be limited. For example, if the progress proportion 414 is within a threshold (e.g., 5 percent) of the elapsed time proportion 406, then a decision can be made not to change priorities.

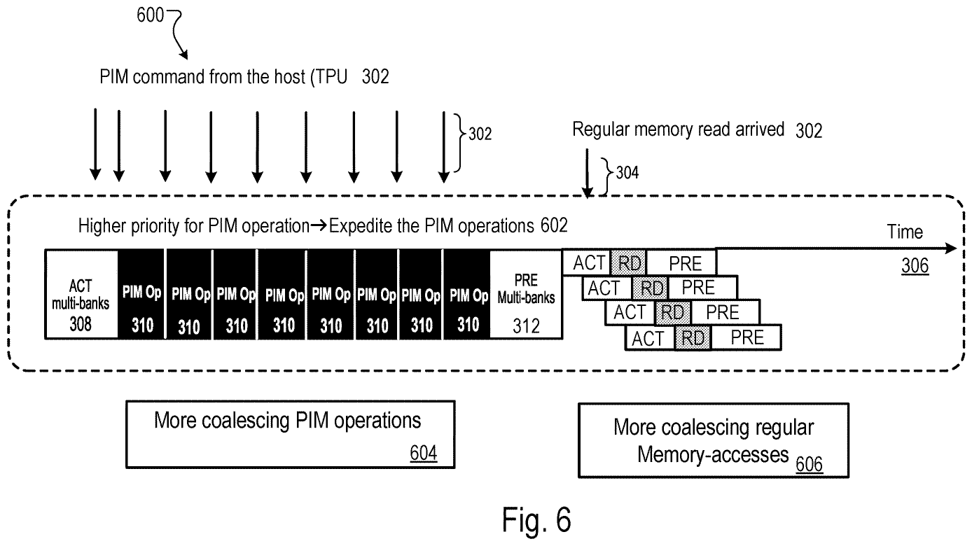

FIG. 6 shows example increases of coalescing of requests that result from changes made to PiM command priorities based on a comparison of the progress proportion 414 and the elapsed time proportion 406.

The disclosed techniques provide a mechanism for efficiently scheduling PiM-command traffic together with memory access transaction traffic. In some implementations, the memory access transaction traffic is referred to alternatively as regular memory transactions or regular memory transaction traffic. Prior approaches in existing systems have QoS schemes for only routine read/write memory access traffic. KPIs for routine (or regular) memory transaction traffic generally include latency and bandwidth requirements. However, PiM command traffic from a host device that is routed to a PiM block of the memory device 122 will have different performance requirements that can vary based on execution conditions and use cases. Thus, techniques are disclosed for a memory controller 105 that provides a mechanism for scheduling and prioritizing PiM command execution to meet ML workload/PiM/HPU performance requirements.

For example, as described with reference to FIGS. 5A and 5B, if the priority assigned to PiM commands is higher than other memory transaction requests/accesses, then the PiM operations (or corresponding PiM commands) will be consecutively scheduled and executed. Doing so will result in improvements to performance and efficiency when executing PiM operations. In some implementations, the improvements are due at least in part to a reduction in overall overhead. This provides an increase in coalescing of PiM operations and an increase of coalescing of memory accesses. That is, it may be more efficient to perform a larger number of similar operations (e.g., PiM operations, or memory accesses) in blocks, rather than interleaving different types of operation.

In some implementations, the PiM command priority can be mapped to latency and bandwidth requests in a QoS scheme that can include example settings in a QoS configuration. For example, during the execution of PiM commands, the host (e.g., HPU 114) can track the progress proportion and compare the progress proportion with the elapsed time proportion. If the progress proportion is less than the elapsed time proportion, then the priority assigned PiM commands can be increased. If the progress proportion is greater than the elapsed time proportion, then the priority assigned to PiM commands can be decreased.

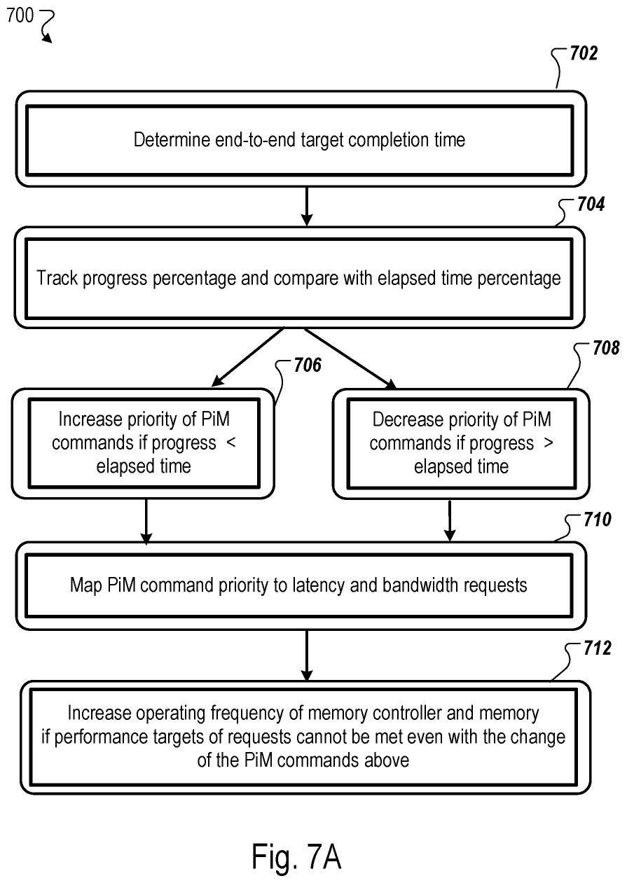

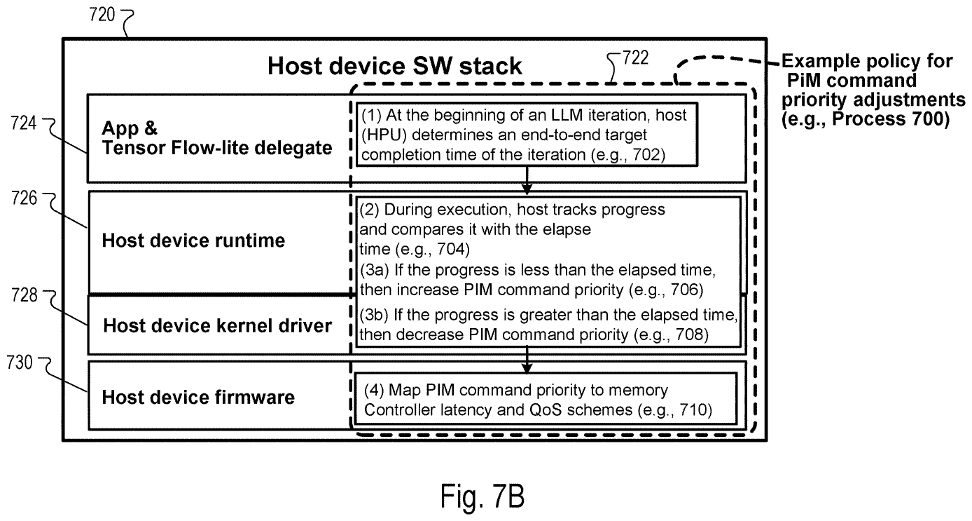

FIG. 7A is an example workflow/process 700 for adjusting priorities of PiM requests, e.g., for controlling memory traffic scheduling in a PiM. At 702, at the beginning of an LLM iteration, the host (e.g., HPU 114) determines the end-to-end target completion time of the iteration. At 704, during the execution of the PiM commands, the host (e.g., HPU 114) tracks the progress proportion and compares the progress proportion to the elapsed time proportion.

At 706, if the progress proportion is less than the elapsed time proportion, then the priority assigned to PiM commands is increased. That is, the priority assigned to the PiM commands is increased to be higher relative to the priority assigned to regular memory transactions.

For example, the PiM commands can be initially assigned a first priority (P3) that is used by the memory controller 105 to prioritize and/or arbitrate its executing of different memory transaction requests from devices of the SoC 102. The system 100 can then increase the priority assigned to the PiM commands to ensure that execution (and/or routing) of the PiM commands satisfy the performance target. For example, to increase the priority, the system 100 can generate and assign a second, different priority (P5) to the PiM commands, where the second priority (P5) is a higher priority than the first priority (P3). In some implementations, the system 100 can adjust the priority assigned to routing PiM commands to the memory device 122, adjust the priority assigned to executing PiM commands in the memory device 122, or both.

At 708, if the progress proportion is greater than the elapsed time proportion, then the priority of PiM commands is decreased. That is, the priority assigned to the PiM commands is decreased to be lower relative to the priority assigned to regular memory transactions. For example, the PiM commands can be initially assigned a first priority (P5) that is used by the memory controller 105 to prioritize and/or arbitrate its executing of different memory transaction requests from devices of the SoC 102. The system 100 can then decrease the priority assigned to the PiM commands to ensure that execution (and/or routing) of the PiM commands satisfy the performance target. For example, to decrease the priority, the system 100 can generate and assign a second, different priority (P3) to the PiM commands, where the second priority (P3) is a lower priority than the first priority (P5).

At 710, the PiM command priority is mapped to latency and bandwidth requests in the memory controller 105. At 712, if the system 100 determines it is not possible to meet (or exceed) performance target requests of PiM commands and regular memory access transactions/traffic, the operating frequency of the memory controller 105 and memory device 122 are increased. For example, the memory controller 105 can generate and/or pass a control signal to the memory device 122 to boost the operating frequency at the memory device 122. A mode or control register of the PiM block can store and/or generate a control signal that is used to increase an operating frequency of the PiM architecture to enable the system 100 to satisfy the performance targets of an ML workload executed at the PiM block. The workload can be executed concurrent with execution of memory read/write transactions at the memory device 122.

The operating frequency of the PiM architecture 200 can be increased or boosted in response to adjusting the first priority to exceed the second priority. For example, adjusting one priority to exceed another priority can include and/or trigger adjusting an operating frequency of the PiM block as well as an operating frequency of other sections of the memory device 122. In some implementations, a change in operating frequency of the memory device 122 can be performed conditionally irrespective of a priority change. For example, an operating frequency can be changed or adjusted to ensure a current set of PiM commands are routed and/or executed to meet or exceed its performance target in accordance with an existing priority.

FIG. 7B shows an example diagram of a host device software stack 720 that implements an example policy 722 for PiM command priority adjustments. In some implementations, one or more of steps (1)-(4) of policy 722 correspond to one or more steps of process 700. The software stack 720 includes an application delegate 724, a host runtime block 726, a host device kernel driver 728, and a host device firmware 730. The application delegate 724 is used to implement item (1) of policy 722 and includes application software (e.g., TensorFlow-lite) and AI/ML neural network models, which can be use-case specific.

The host runtime block 726 and the host device kernel driver 728 are used to implement items (2), (3a), and (3b) of policy 722. In some implementations, the host runtime block 726 is a runtime API (Application Programming Interface) that provides abstractions for an application to construct a host processing unit driver, register ML models, and run/execute inferences using the ML models. Relatedly, the host device kernel driver 728 can be a programming interface that allows communication between a device hardware and certain higher-level software applications. The host device firmware 730 is used to implement item (4) of policy 722. In some implementations, host device firmware 730 is low-level software that directly controls hardware aspects of the host device, including setting certain registers and/or register values.

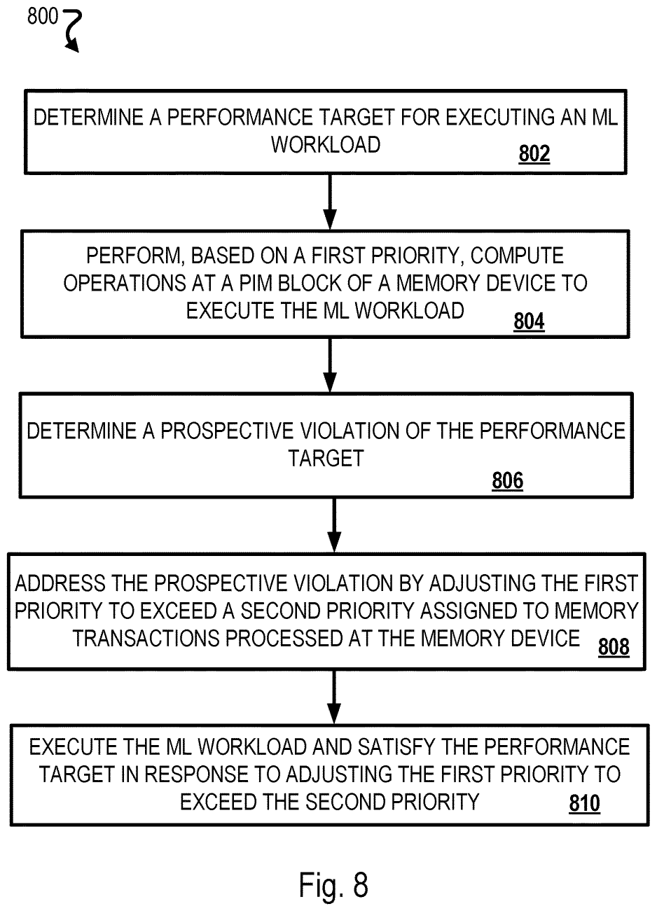

FIG. 8 is an example process 800 for memory access scheduling in an integrated computing system, including memory transaction/operation scheduling for concurrent processing in a DRAM device, such as memory device 122. Process 800 is implemented or executed at system 100 using at least the SoC 102 and memory device 122 described above. Hence, descriptions of process 800 will reference the above-mentioned computing resources of system 100. In some examples, the steps or actions of process 800 are enabled by programmed software instructions, firmware instructions, or both. Each type of instruction may be stored in a non-transitory machine-readable storage device and is executable by one or more of the processors or other resources described in this specification.

Referring again to process 800, the system 100 determines a performance target for executing a machine-learning (ML) workload (802). For example, the ML workload can be for a large language model (“LLM”) executed by a host device of the SoC 102, such as the HPU 114. In some implementations, the ML workload corresponds to an iteration of the LLM and the performance target is an end-to-end target completion time for executing an iteration of the LLM.

To execute the ML workload at the integrated circuit system, the system 100 performs compute operations at a PiM block 202 of the memory device 122 based on a first priority (804). For example, the PiM block 202 can perform the computations to generate accumulated values from sets of weight values and activation inputs obtained from memory banks of different bank groups in the memory device 122. In some implementations, the accumulated values are generated based on neural network computations performed using a computational array of the PiM block 202.

The system 100 determines a prospective violation of the performance target (806). For example, the system 100 can determine a prospective violation in response to determining that an actual time needed to execute the ML workload will exceed the end-to-end target completion time. The system 100 addresses the prospective violation by adjusting the first priority to exceed a second priority assigned to memory transactions processed at the memory device 122 (808).

The system executes the ML workload and satisfies the performance target in response to adjusting the first priority to exceed the second priority (810). For example, after adjusting the first priority to exceed the second priority, the system 100 then performs any remaining compute operations based on the adjusted first priority. Adjusting the first priority to exceed the second priority causes the memory controller 105 to prioritize execution of PiM commands at the memory device 122 over execution of memory transactions at the memory device 122. Prioritizing execution of the PiM commands over one or more other memory device operations enables the ML workload to be executed while also satisfying the performance target.

The first priority can be a PiM command routing and execution priority, whereas the second priority can be a memory access transaction routing and execution priority. In some implementations, the system 100 initially prioritizes executing memory transactions at the memory device 122 over executing PiM commands at the memory device 122. The system 100 can set this initial priority by configuring the second priority to exceed the first priority such that the SoC 102 prioritizes memory transaction requests from IP devices 108 that request read/write access to memory banks of the memory device 122.

The system 100 can then prioritize execution of PiM commands at the memory device over execution of memory transactions at the memory device 122 by adjusting the first priority to exceed the second priority. For example, as indicated above, the system 100 can configure this priority change in response to determining that the actual time needed to execute the ML workload will violate the performance target or deviate from the performance target. In some implementations, execution of the ML workload can be (or become) exceedingly fast such that prioritizing execution of PiM commands over execution of memory transactions is not (or longer) required to satisfy the performance target.

In these instances, the system 100 can reprioritize memory transactions over executing PiM commands by adjusting the second priority to exceed the first priority used to perform the compute operations. In some implementations, the system 100 performs the adjustments to the first priority or to the second priority based on a Quality-of-Service (“QoS”) policy implemented by the memory controller 105 of the SoC 102.

In concurrent use case scenarios where multiple IPs (e.g., CPU 104, GPU 118, Camera/ISP 112, etc.) generate memory transaction traffic, such as data reads and writes, for routing to the memory device 122, a host device (e.g., TPU 114) can concurrently generate PiM-related commands for routing to a PiM block 202 of the memory device 122 using the same memory-path. Thus, the PiM commands and the routine memory read/write transactions can share a common set of interface communication channels that exist between the SoC 102 and the memory device 122. The system 100 can be configured to stagger and/or interleave a routing of PiM commands and routine memory access transactions (e.g., read/write traffic) to memory device 122. For example, the memory controller 105 can stagger and/or interleave the routing such that the PiM commands and memory access operations can be processed concurrently at the memory device 122 for one or more tasks of the ML workload executed at the memory device 122.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus.

Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “computing system” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array), an ASIC (application specific integrated circuit), or a GPGPU (General purpose graphics processing unit).

Computers suitable for the execution of a computer program include, by way of example, can be based on general or special purpose microprocessors or both, or any other kind of central processing unit. Generally, a central processing unit will receive instructions and data from a read only memory or a random access memory or both. Some elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination.

Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A method implemented using an integrated circuit comprising a System-on-Chip (“SoC”) and a memory device coupled to the SoC, the method comprising:
determining a performance target for executing a machine-learning (ML) workload;
scheduling, based on a first priority, commands for compute operations at a processor-in-memory (“PiM”) block of the memory device to execute the ML workload at the integrated circuit;
determining a prospective violation of the performance target;
addressing the prospective violation by adjusting the first priority to exceed a second priority assigned to memory read/write transactions provided to the memory device; and
satisfying the performance targets of the ML workload at the PiM block and memory read/write transactions in response to adjusting the first priority to exceed the second priority and adjusting an operating frequency of the memory device and the PiM block.

2. The method of claim 1, wherein
i) the commands and the memory read/write transactions are processed concurrently for at least one task of the ML workload; and
ii) the commands and the memory read/write transactions share an interface communication channel between the SoC and the memory device.

3. The method of claim 2, wherein executing the ML workload and satisfying the performance target comprises:
after adjusting the first priority to exceed the second priority, performing any remaining compute operations based on an adjusted first priority that prioritizes sending PiM commands to the PiM inside the memory device over sending read/write memory transactions.

4. The method of claim 1, wherein:
the first priority is a PiM command routing and execution priority; and
the second priority is a memory access transaction routing and execution priority.

5. The method of claim 4, wherein adjusting the first priority to exceed the second priority occurs at a first time period to prioritize PiM commands over memory access transactions, and the method further comprises:
reprioritizing memory access transactions over PiM commands at a second time period by adjusting the second priority to exceed the first priority used to perform the compute operations, wherein the second time period occurs later in time than the first time period.

6. The method of claim 1, wherein the memory transactions are processed at the memory device concurrently with performing the compute operations at the PiM block of the memory device.

7. The method of claim 1, wherein:
i) the ML workload is for a large language model (“LLM”); and
ii) the ML workload corresponds to an iteration of the LLM; and
iii) the performance target is an end-to-end target completion time for executing an iteration of the LLM.

8. The method of claim 7, wherein determining a prospective violation of the performance target of the PiM processing ML workload comprises:
determining a prospective violation in response to determining that an actual time needed to execute the ML workload will exceed the end-to-end target completion time.

9. The method of claim 1, wherein adjusting the first priority to exceed the second priority comprises:
adjusting the first priority to exceed the second priority based on a Quality-of-Service (“QoS”) policy implemented by a memory controller of the SoC.

10. The method of claim 9, further comprising:
based on the QoS policy, interspersing PiM commands with memory transaction requests;
routing, to the memory device, the PiM commands interspersed with the memory transaction requests; and
processing the PiM commands and the memory transaction requests concurrently at the memory device.

11. The method of claim 1, wherein:
i) the memory read/write transactions are for data reads and data writes from the SoC to the memory device;
ii) the data reads and the data writes are for data transfer and are distinct from commands that are provided to the PiM block in the memory device; and
iii) the performance target for executing the ML workload comprises a latency target of memory read/write transactions and a bandwidth or throughput target for each individual memory read/write transaction.

12. A method implemented using a hardware integrated circuit comprising a memory device and a processing-in-memory (“PiM”) architecture in the memory device, the method comprising:
determining, for a set of PiM commands, an end-to-end target completion time for executing PiM operations in a PiM architecture;
tracking, during execution of the PiM operations in the PiM architecture, a progress proportion of completed PiM operations relative to an elapsed time proportion of the end-to-end target completion time;
in response to determining that the progress proportion is less than the elapsed time proportion, increasing a scheduling priority of remaining PiM operations relative to priorities of memory transactions for execution at a memory bank of the memory device; and
in response to increasing the scheduling priority of the remaining PiM operations, executing the remaining PiM operations using the processing-in-memory architecture and executing the memory transactions by accessing the memory bank of the memory device.

13. The method of claim 12, further comprising:
determining the elapsed time proportion as a fraction of an elapsed time of the completed PiM operations divided by the end-to-end target completion time.

14. The method of claim 13, further comprising:
determining the progress proportion as a fraction of a number of completed operations divided by a sum of the number of completed operations and the number of remaining operations.

15. The method of claim 12, further comprising:
mapping PiM command priorities to latency and bandwidth requests.

16. The method of claim 12, further comprising:
determining that performance targets of PiM commands and memory transactions are not satisfied; and
increasing a respective operating frequency of: i) a memory controller of the hardware integrated circuit, ii) the memory device, and iii) a processor in the PiM architecture.

17. An integrated circuit comprising:
a System-on-Chip (“SoC”);
a memory device coupled to the SoC, and
a processor and a non-transitory machine-readable storage medium for storing instructions that are executable by the processor to cause performance of operations comprising:
determining a performance target for executing a machine-learning (ML) workload;
scheduling, based on a first priority, commands for compute operations at a processor-in-memory (“PiM”) block of the memory device to execute the ML workload at the integrated circuit;
determining a prospective violation of the performance target;
addressing the prospective violation by adjusting the first priority to exceed a second priority assigned to memory read/write transactions to the memory device; and
satisfying the performance target of the ML workload at the PiM block and the memory read/write transactions in response to adjusting the first priority to exceed the second priority and adjusting an operating frequency of the memory device and the PiM block.

18. The integrated circuit of claim 17, wherein executing the ML workload and satisfying the performance target comprises:
after adjusting the first priority to exceed the second priority, performing any remaining compute operations based on an adjusted first priority that prioritizes sending PiM commands to the memory device over memory read/write transactions at the memory device.

19. The integrated circuit of claim 17, wherein:
the first priority is a PiM command routing and execution priority; and
the second priority is a memory access transaction routing and execution priority.

20. The integrated circuit of claim 19, wherein adjusting the first priority to exceed the second priority occurs at a first time period to prioritize PiM commands over memory access transactions, and the operations further comprise:
reprioritizing access memory transactions over PiM commands at a second time period by adjusting the second priority to exceed the first priority used to perform the compute operations, wherein the second time period occurs later in time than the first time period.

21. (canceled)

22. (canceled)

23. (canceled)
